(19) United States
(12) Patent Application Publication
(10) Pub. No.: US 2007/0224369 A1
(43) Pub. Date: Sep. 27, 2007

(54) Liquid crystal device, method for manufacturing the same, and electronic apparatus

(75) Inventor: Hiroyuki Kojima, Suwa-shi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 11/728,024

(22) Filed: Mar. 23, 2007

(30) Foreign Application Priority Data
Mar. 24, 2006 (JP) 2006-082250
Mar. 24, 2006 (JP) 2006-082251
Mar. 24, 2006 (JP) 2006-082252

(51) Int. Cl. C09K 19/56; G02F 1/1337

(52) U.S. Cl. 428/1.2; 349/124; 349/123; 252/299.4

(57) ABSTRACT

A method is provided for manufacturing a liquid crystal device including a substrate and an inorganic homeotropic alignment layer made of an inorganic material and aligning liquid crystal molecules having a negative dielectric constant anisotropy in a direction tilted at a predetermined angle from the direction perpendicular to the surface of the substrate. The method includes forming the inorganic homeotropic alignment layer and treating the surface of the inorganic homeotropic alignment layer with an aluminate coupling agent.

This application claims benefit of Japanese Application No. 2006-082250, 2006-082251 and 2006-082252 filed on Mar. 24, 2006 the contents of which are incorporated by this reference.

### BACKGROUND

1. Technical Field

The present invention relates to a liquid crystal device including an alignment layer made of an inorganic material, a method for manufacturing the same, and an electronic apparatus.

2. Related Art

It is desired that light valves of electronic apparatuses, such as liquid crystal projectors, be small in association with the demand for high definition, high brightness, and low cost, and the intensity of light coming into the light valve is increasing. Accordingly, a light-resistant, heat-resistant inorganic alignment layer is thought of as an alternative to the organic alignment layer made of an organic material used in liquid crystal devices, such as light valves of liquid crystal projectors.

An obliquely deposited layer made of an inorganic oxide, such as silica (SiO₂), has been known as an inorganic alignment layer used for homeotropic alignment. For example, an obliquely deposited SiO₂ layer is formed by obliquely depositing SiO₂ onto the surface of a substrate at an angle of 30° or more with respect to the surface of the substrate, and the resulting SiO₂ layer can homeotropically align liquid crystal molecules having a negative dielectric constant anisotropy at a predetermined tilt angle.

Inorganic materials such as SiO₂ easily react with external water and typically have the silanol group (—Si—OH) at the surface of the molecule. Since the silanol group is highly reactive, a film having the silanol group could react with the liquid crystal molecules of the liquid crystal layer disposed between substrates unless any measure is taken. Particularly in a case of, for example, using a liquid crystal device as a light valve of a projector or the like, the liquid crystal device is irradiated to strong light and accordingly a photochemical reaction can easily occur between the silanol groups and the liquid crystal molecules. If such a photochemical reaction repeatedly occurs in each operation of the liquid crystal device, the ability of the alignment layer to align liquid crystal molecules is reduced and consequently the displaying performance of the liquid crystal device is degraded. Thus, the lifetime of the liquid crystal device, that is, the period for which the device can display high-quality images, is reduced.

In order to overcome this disadvantage, for example, Japanese Unexamined Patent Application Publication No. 2000-47211 has disclosed the technique of surface-treating an inorganic alignment layer, such as a SiO₂ alignment layer, with a higher alcohol. Since this technique substitutes the higher alcohol for the OH group at the surface of the alignment layer, it is expected to inhibit the photochemical reaction at the surface of the alignment layer.

In addition to the above-described inorganic homeotropic alignment layer, an inorganic homogeneous alignment layer that aligns liquid crystal molecules having a positive dielectric constant anisotropy at a predetermined pretilt angle in a direction along the surface of the substrate is known as an obliquely deposited inorganic oxide alignment layer. In this alignment layer, the photochemical reaction of liquid crystal molecules at the surface of the alignment layer can be inhibited by surface treatment with a higher alcohol.

However, alcohol generally has a low binding power at the surface of the alignment layer. If an inorganic homeotropic alignment layer is surface-treated with an alcohol as disclosed in Japanese Unexamined Patent Application Publication No. 2000-47211, water contained in the liquid crystal layer reaches the boundary of the alignment layer to separate the alcohol and thus the silanol group can be formed again.

In addition, inorganic homogeneous alignment layers generally have lower ability to align liquid crystal molecules than inorganic homeotropic alignment layers, and it is accordingly difficult for the inorganic homogeneous alignment layers to align liquid crystal molecules stably. It is therefore desired that the surface of inorganic homogeneous alignment layers also be further improved.

### SUMMARY

An advantage of some aspects of the invention is that it provides a liquid crystal device including an alignment layer whose surface is inhibited from reacting with liquid crystal molecules so as to display high-quality images over a long term, a method for manufacturing the same, and an electronic apparatus.

According to an aspect of the invention, there is provided a method for manufacturing a liquid crystal device including a substrate and an inorganic homeotropic alignment layer made of an inorganic material and aligning liquid crystal molecules having a negative dielectric constant anisotropy in a direction tilted at a predetermined angle from the direction perpendicular to the surface of the substrate. The method includes forming the inorganic homeotropic alignment layer and treating the surface of the inorganic homeotropic alignment layer with an aluminate coupling agent.

According to another aspect of the invention, there is provided a method for manufacturing a liquid crystal device including a substrate and an inorganic homeotropic alignment layer made of an inorganic material and aligning liquid crystal molecules having a negative dielectric constant anisotropy in a direction tilted at a predetermined angle from the direction perpendicular to the surface of the substrate. The method includes forming the inorganic homeotropic alignment layer and treating the surface of the inorganic homeotropic alignment layer with a titanate coupling agent.

According to further aspect of the invention, there is provided a method for manufacturing a liquid crystal device including a substrate and an inorganic homogeneous alignment layer made of an inorganic material and aligning liquid crystal molecules having a positive dielectric constant anisotropy in a direction tilted at a predetermined angle from the direction parallel to the surface of the substrate. The method includes forming the inorganic homogeneous alignment layer and treating the surface of the inorganic homogeneous alignment layer with an epoxy silane coupling agent.

According to still another aspect of the invention, there is provided a method for manufacturing a liquid crystal device including a substrate and an inorganic homogeneous alignment layer made of an inorganic material and aligning liquid crystal molecules having a positive dielectric constant anisotropy in a direction tilted at a predetermined angle from the direction parallel to the surface of the substrate. The method includes forming the inorganic homogeneous alignment layer and treating the surface of the inorganic homogeneous alignment layer with an amino silane coupling agent.

### BRIEF DESCRIPTION OF THE DRAWINGS

The invention will be described with reference to the accompanying drawings, wherein like numbers reference like elements.

FIG. 1 is a plan view of the entire structure of a liquid crystal device according to a first embodiment of the invention.

FIG. 2 is a sectional view taken along line II-II shown in FIG. 1.

FIG. 3 is an equivalent circuit diagram including elements of a plurality of pixels and wires of the liquid crystal device according to the first embodiment.

FIG. 4 is a schematic representation of a surface-treated surface of an alignment layer of the liquid crystal device according to the first embodiment.

FIG. 5 is a process flow chart of a manufacturing process of the liquid crystal device according to the first embodiment.

FIG. 6 is a schematic representation of a surface-treated surface of an alignment layer of a liquid crystal device according to a second embodiment of the invention.

FIG. 7 is a schematic representation of a surface-treated surface of an alignment layer of a liquid crystal device according to a third embodiment of the invention.

FIG. 8 is a representation of a projection color display device including a liquid crystal device according to an embodiment of the invention.

### DESCRIPTION OF EXEMPLARY EMBODIMENTS

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

### First Embodiment

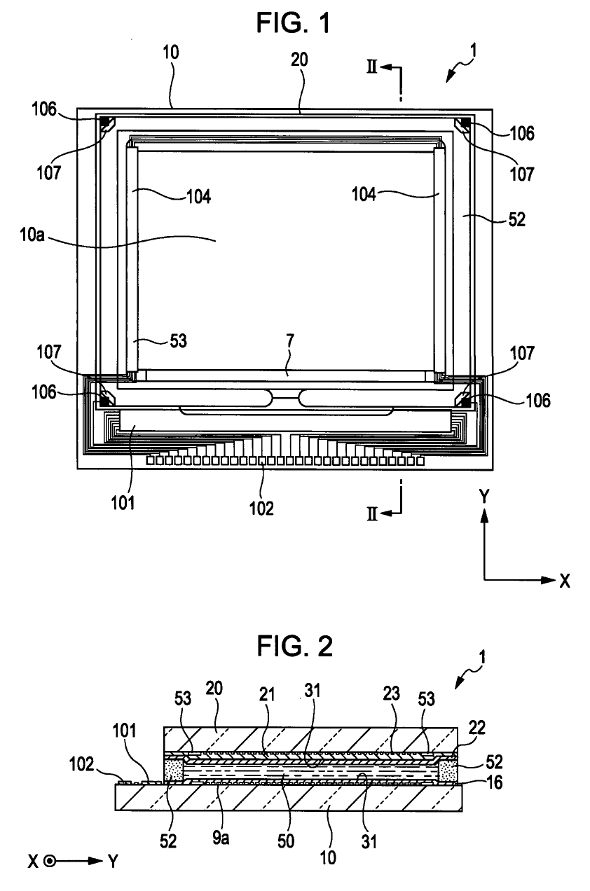

A liquid crystal device according to a first embodiment of the invention and its manufacturing method will now be described with reference to FIGS. 1 to 5. The liquid crystal device of the present embodiment is of a driving circuit-built-in TFT active matrix-driving type.

### Structure of the Liquid Crystal Device

First, the entire structure of the liquid crystal device according to the present embodiment will be described with reference to FIGS. 1 and 2. FIG. 1 is a plan view of the liquid crystal device including a TFT array substrate and elements overlying the substrate when viewed from the opposing substrate side. FIG. 2 is a sectional view of the liquid crystal device taken along line II-II shown in FIG. 1. The layers and members shown in each figure are illustrated on different scales so as to be recognized.

As shown in FIGS. 1 and 2, the liquid crystal device 1 of the present embodiment includes a TFT array substrate 10 and an opposing substrate 20 that oppose each other. A liquid crystal layer 50 is held between the TFT array substrate 10 and the opposing substrate 20, and the TFT array substrate 10 and the opposing substrate 20 are bonded together with a sealant 52 provided in a sealing region in the outer area of the image display region 10a.

The sealant 52 is made of for example, UV curable resin, thermosetting resin, or UV-curable thermosetting resin capable of bonding the two substrates together, and is cured after being applied onto the TFT array substrate 10 by, for example, UV irradiation or heating in the manufacturing process.

As shown in FIG. 1, a light-shielding frame film 53 is provided inside the sealing region, where the sealant 52 is applied, of the opposing substrate 20, along the sealing region. The light-shielding frame film 53 defines the frame region of the image display region 10a. Part or the entirety of the light-shielding frame film 53 may be provided as an internal light-shielding film in the TFT array substrate 10.

A data line-driving circuit 101 and external circuit connecting terminals 102 are disposed along a side of the TFT array substrate 10 outside the sealing region where the sealant 52 is provided. Inside the sealing region along this side, a sampling circuit 7 is disposed so as to be covered with the light-shielding frame film 53. Scanning line-driving circuits 104 are disposed so as to be covered with the light-shielding frame film 53 inside the sealing region along two sides adjacent to that side along the sampling circuit 7.

The TFT array substrate 10 has vertically conducting terminals 106 for connecting both substrates with vertical conductors 107 in the regions opposing four corners of the opposing substrate 20. Electrical continuity is thus established between the TFT array substrate 10 and the opposing substrate 20.

As shown in FIG. 2, a multilayer structure is formed on the TFT array substrate 10. The multilayer structure includes pixel switching TFTs (thin film transistors) acting as driving elements, scanning lines, and data lines. Pixel electrodes 9a are formed of a transparent material, such as ITO (indium tin oxide), in a predetermined island-shaped pattern for each pixel as an uppermost layer of the multilayer structure, but the details of the structure are not shown in FIG. 2. Each pixel electrode 9a is covered with an alignment layer 16 made of an inorganic material, such as silica (SiO₂).

The opposing substrate 20 has a light-shielding film 23 formed on the surface opposing the TFT array substrate 10. The light-shielding film 23 is formed in a grid manner when viewed toward the opposing surface of the opposing substrate 20. The light-shielding film 23 defines non-aperture regions of the opposing substrate 20, and the regions segmented by the light-shielding film 23 act as aperture regions. Alternatively, the light-shielding film 23 may be formed in a striped manner so that the light-shielding film 23 and the data lines and other elements of the TFT array substrate 10 define the non-aperture regions.

An opposing electrode 21 is formed of a transparent material, such as ITO, on the light-shielding film 23, opposing the plurality of pixel electrodes 9a. In addition, color filters (not shown in FIG. 2) for forming color images may be provided in the image display region 10a above the light-shielding film 23 in regions including the aperture regions and part of the non-aperture regions.

The multilayer structure including the above-described components formed on the opposing surface of the opposing substrate 20 has an alignment layer 22 made of an inorganic material, such as silica (SiO₂). The opposing electrode 21 is disposed as the upper most layer of the multilayer structure of the opposing substrate 20 and the alignment layer 22 is formed over the opposing electrode 21.

An alignment layer may be formed on the opposing surface of either the TFT array substrate 10 or the opposing substrate 20. However, the alignment layers 16 and 22 of the liquid crystal device 1 are made of an inorganic material in order to increase the lifetime. In addition, in order to align liquid crystal molecules in a homeotropic alignment mode, the alignment layers 16 and 22 are inorganic homeotropic alignment layers made of columnar crystals grown at a predetermined angle with respect to the surface of the substrate. More specifically, the alignment layers 16 and 22 are inorganic tilted homeotropic alignment layers that align liquid crystal molecules in a direction tilted at a predetermined angle from the direction perpendicular to the surfaces of the substrates 10 and 20. The liquid crystal layer 50 is made of a liquid crystal containing, for example, liquid crystal molecules having at least one negative dielectric constant anisotropy, and is in a predetermined aligned state between the pair of alignment layers 16 and 22 when no electric field is applied from the pixel electrode 9a.

The surfaces of the alignment layers 16 and 22 are treated with a coupling agent before injecting the liquid crystal to form the liquid crystal layer 50, as described later.

In addition to the data line-driving circuit 101, the scanning line-driving circuits 104, and the sampling circuit that samples image signals on the image signal lines and transmits the signals to the data lines, the TFT array substrate 10 shown in FIGS. 1 and 2 has a precharge circuit that supplies a precharge signal with a level of a predetermined voltage to a plurality of data lines prior to the image signals, and a test circuit for checking for defects and testing the quality of the liquid crystal device during the manufacturing process or before shipping.

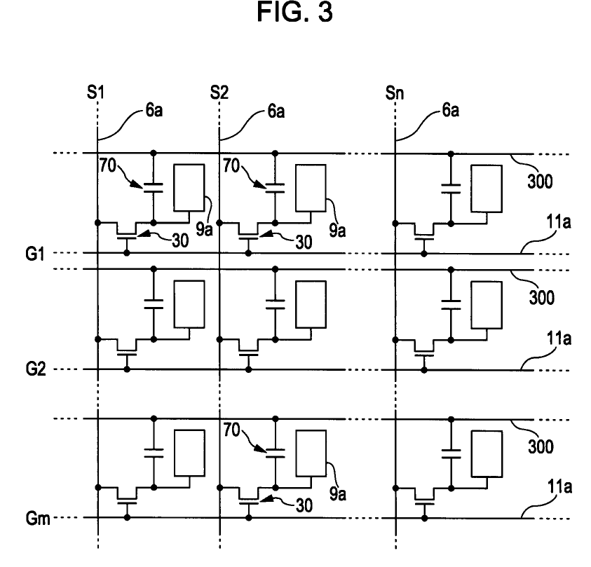

Turning now to FIG. 3, the structure of the circuit and the operation of the liquid crystal device 1 will now be described. FIG. 3 is an equivalent circuit diagram of a plurality of pixels of the image display region of the liquid crystal device, including several types of elements and wires and arranged in a matrix manner.

Each of the plurality of pixels defining the image display region 10a of the liquid crystal device 1 according to the present embodiment includes a pixel electrode 9a, a TFT 30 for controlling the switching of the pixel electrode 9a, and the source of the TFT 30 is electrically connected to a data line 6a to which image signals are transmitted, as shown in FIG. 3. The image signals S1 to Sn written in the respective data lines 6a may be transmitted one by one in that order, or transmitted for each group constituted of plural adjacent data lines 6a.

The gate of each TFT 30 is electrically connected to a scanning line 11a or a gate electrode so that pulsed scanning signals G1 to Gm are applied one by one in that order to the corresponding scanning line 11a or gate electrode at a predetermined timing. Each pixel electrode 9a is electrically connected to the drain of the corresponding TFT 30. By closing the switch of the TFT 30 serving as a switching device for a predetermined time, the corresponding one of the image signals S1 to Sn transmitted from the data lines 6a is written at a predetermined timing.

Each of the image signals S1 to Sn with a predetermined level written in the liquid crystal being an electrooptic material through the pixel electrode 9a is held for a predetermined period between the pixel electrode 9a and the opposing electrode 21 of the opposing substrate 20. The molecules of the liquid crystal change their orientation or order depending on the level of applied voltage, thereby modulating light to form an image with gradations. The transmittances of incident light are reduced according to voltages applied to the pixels in a normally white mode, and the transmittances are increased according to the voltages applied to the pixels in a normally black mode. Thus, the liquid crystal device, as a whole, emits light with a contrast according to the image signals.

In order to prevent the held image signals from leaking, storage capacitors 70 are provided in parallel with liquid crystal capacitors formed between each pixel electrode 9a and the opposing electrode 21. The storage capacitors 70 are disposed along the scanning lines 11a and each includes a pixel potential capacitor electrode and a constant potential capacitor electrode 300.

### Chemical Structure at the Surface of Alignment Layer

The liquid crystal device 1 according to the present embodiment includes the alignment layers 16 and 22, and the entire surfaces of the alignment layers are treated with an aluminate coupling agent expressed by general formula (1). Specifically, the aluminate coupling agent reacts with the hydroxy group (—OH group) of the silanol group being the active site present at the surface of each of the alignment layers 16 and 22, so that a reaction layer 31 is formed at the surfaces of the alignment layers 16 and 22. Thus, the silanol group photochemically reacting with the liquid crystal molecules can be reduced at the surfaces of the alignment layers 16 and 22.

The reaction layer 31 formed of the aluminate coupling agent can trap water. Accordingly, water contained in the liquid crystal layer 50 can be prevented from reaching the surfaces of the alignment layers 16 and 22 to form the silanol group again.

The reaction layer 31 of the aluminate coupling agent has a good adhesion to the sealant 52. By extending the reaction layers 31 of the alignment layers 16 and 22 to the sealing regions, the reaction layers 31 enhance the adhesion between the substrates 10 and 20 and the sealant 52 and trap water, thereby preventing water from permeating into the liquid crystal layer 50 from the outside of the liquid crystal device 1 with reliability. From the viewpoint of preventing water from permeating into the liquid crystal layer, at least the regions bonded to the sealant 52 of the surfaces of the alignment layers 16 and 22 may be treated with the aluminate coupling agent, and the other region may be treated with a coupling agent other than the aluminate coupling agent.

R—(CₘH₂ₘ)—Al—(OCₙH₂ₙ₊₁)₃ (1)

### (R represents a carboxy group, m represents an integer in the range of 0 to 2, and n represents an integer in the range of 0 to 2.)

Since the reaction layer 31 has a much smaller thickness than the alignment layers 16 and 22, the reaction layer 31 does not reduce the ability of the alignment layers 16 and 22 to align liquid crystal molecules.

Preferably, acetoalkoxyaluminum diisopropylate expressed by chemical formula (2) can be used as the aluminate coupling agent expressed by general formula (1).

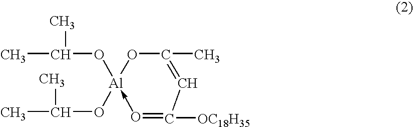

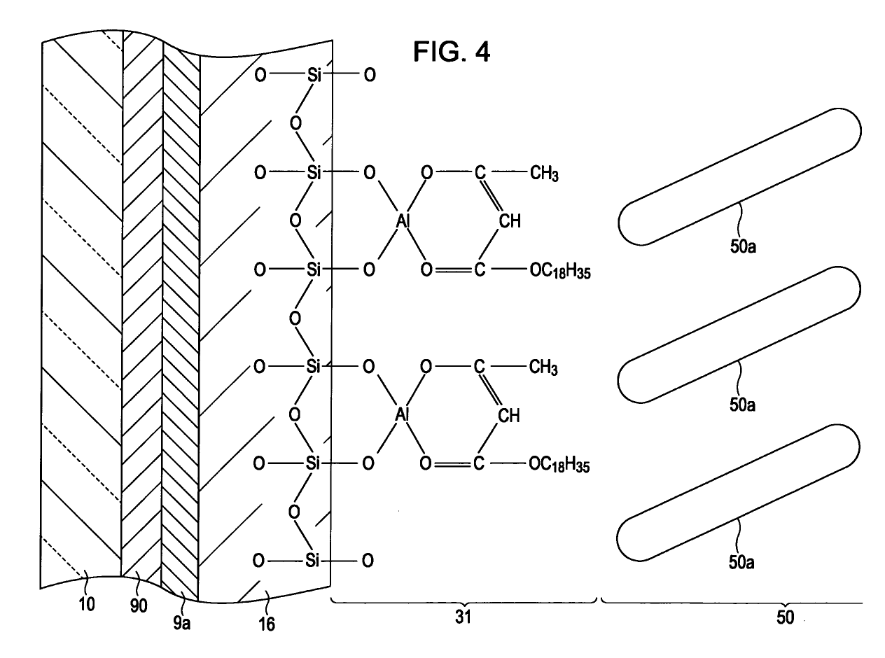

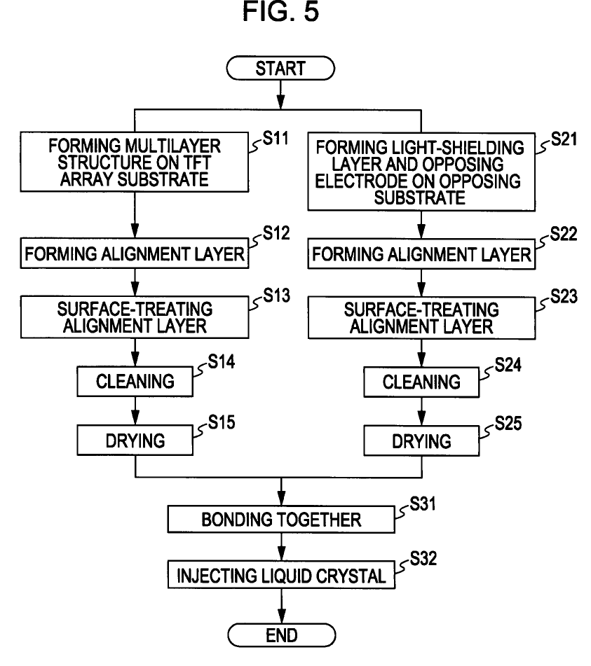

In this instance, the reaction layers 31 are formed over the alignment layers 16 and 22 by dealcoholization of acetoalkoxyaluminum diisopropylate. FIG. 4 schematically shows the sectional structure of the alignment layer 16 and its reaction layer 31 over the TFT array substrate 10, corresponding to the sectional view shown in FIG. 2.

In FIG. 4, the TFT array substrate 10 has the multilayer structure 90 including TFTs and other elements on the surface opposing the liquid crystal layer 50, and the pixel electrodes 9a formed for each pixel as the uppermost layer of the multilayer structure 90. The inorganic material is deposited in such a manner that columnar structures of the inorganic material are arranged on the pixel electrode 9a at a predetermined angle with respect to the surface of the TFT array substrate 10, thus forming the alignment layer 16. The thus formed alignment layer 16 can control the alignment of liquid crystal molecules 50a by its surface structure. Specifically, the liquid crystal molecules 50a are aligned in a direction tilted at a predetermined angle from the direction perpendicular to the surface of the substrate 10 (tilted homeotropic alignment), as shown in FIG. 4. The alignment layer 22 of the opposing substrate 20 also aligns the liquid crystal molecules 50a in the same manner.

The surface treatment of the alignment layers 16 and 22 is performed by immersing and heating the substrate having the inorganic homeotropic alignment layer in a solution of, for example, an aluminate coupling agent with a predetermined concentration in an organic solvent. The surface treatment of the alignment layer is not limited to this method and may be performed by, for example, spin-coating the alignment layer with a coupling agent solution. If only the regions coming into contact with the sealant 52 of the alignment layers 16 and 22 are surface-treated with an aluminate coupling agent, the coupling agent may be mixed with the sealant 52 in advance. Thus, the alignment layers can be surface-treated without performing an additional step.

In the liquid crystal device 1 according to the present embodiment, the inorganic homeotropic alignment layer is surface-treated with an aluminate coupling agent so that the silanol group is replaced with the coupling agent to reduce the silanol group from the surface of the alignment layer. Thus, the photochemical reaction between the liquid crystal molecules and the alignment layer can be inhibited. In addition, the reaction layer formed of the aluminate coupling agent on the surface of the alignment layer can trap water. Water contained in the liquid crystal layer can be prevented from reaching the surface of the alignment layer to form the silanol group again. Thus, the photochemical reaction between the liquid crystal molecules and the inorganic homeotropic alignment layer can be reduced, and consequently high-quality images can be displayed over a long term.

### Method for Manufacturing the Liquid Crystal Device

A method for manufacturing the liquid crystal device will be described with reference to FIG. 5. FIG. 5 is a process flow chart of the method for manufacturing the liquid crystal device according to the present embodiment.

As shown in FIG. 5, the TFT array substrate 10 is subjected to deposition, such as vapor deposition or sputtering, patterning by etching or photolithography, and heat treatment to form the multilayer structure 90 (see FIG. 4) including data lines 6a, scanning lines 11a, and TFTs 30, and the pixel electrodes 9a are formed of, for example, ITO as the uppermost layer of the multilayer structure by, for example, sputtering (Step S11).

Subsequently, the alignment layer is formed by performing, for example, oblique evaporation on the TFT array substrate 10. Thus, the silica (SiO₂) alignment layer 16 on the surface of the pixel electrode 9a of the TFT array substrate 10 to a thickness of, for example, about 40 nm (Step S12). The alignment layer 16 may be formed by anisotropic sputtering or coating, such as an ink jet method. In this instance, inorganic vapor, such as silica (SiO₂) vapor, produced from the deposition source comes into contact with the uppermost layer of the multilayer structure of the TFT array substrate 10, so that the inorganic material is vapor-deposited on the multilayer structure 90. The inorganic material is deposited in such a manner that columnar structures of the inorganic material are arranged on the pixel electrode at a predetermined angle with respect to the surface of the substrate.

Then, the surface of the alignment layer 16 opposing the liquid crystal layer 50 is treated with a coupling agent solution prepared by dissolving, for example, an aluminate coupling agent in a solvent (Step S13).

The surface-treated inorganic homeotropic alignment layer is cleaned with a pure solvent containing no silane compounds or impurities (Step S14). Then, the inorganic homeotropic alignment layer is dried (Step S15). The opposing substrate 20 is prepared almost in parallel with Steps S11 to S15. Specifically, the light-shielding film and the opposing electrode are formed (Step S21) and, then, the inorganic homeotropic alignment layer is formed (Step S22). Subsequently, the inorganic homeotropic alignment layer of the opposing substrate 20 is also surface-treated with a coupling agent solution containing an aluminate coupling agent in the same manner as the alignment layer of the TFT array substrate 10 (Step s23). The inorganic homeotropic alignment layer of the opposing substrate 20 is cleaned (Step S24) and dried (Step S25).

Then, The TFT array substrate 10 and the opposing substrate 20 that have been subjected to the steps up to the drying step are bonded together with a sealant 52 in between in such a manner that the alignment layer 16 of the TFT array substrate 10 and the alignment layer 22 of the opposing substrate 20 are opposed to each other (Step S31).

Then, a liquid crystal is injected into the space between the bonded TFT array substrate 10 and opposing substrate 20 (Step S32).

Thus, the method for manufacturing the liquid crystal device according to the present embodiment can produce the above-described liquid crystal device. Since in this method, the surfaces of the alignment layers 16 and 22 opposing the liquid crystal layer 50 are treated with an aluminate coupling agent, the resulting liquid crystal device can exhibit high light resistance.

### Second Embodiment

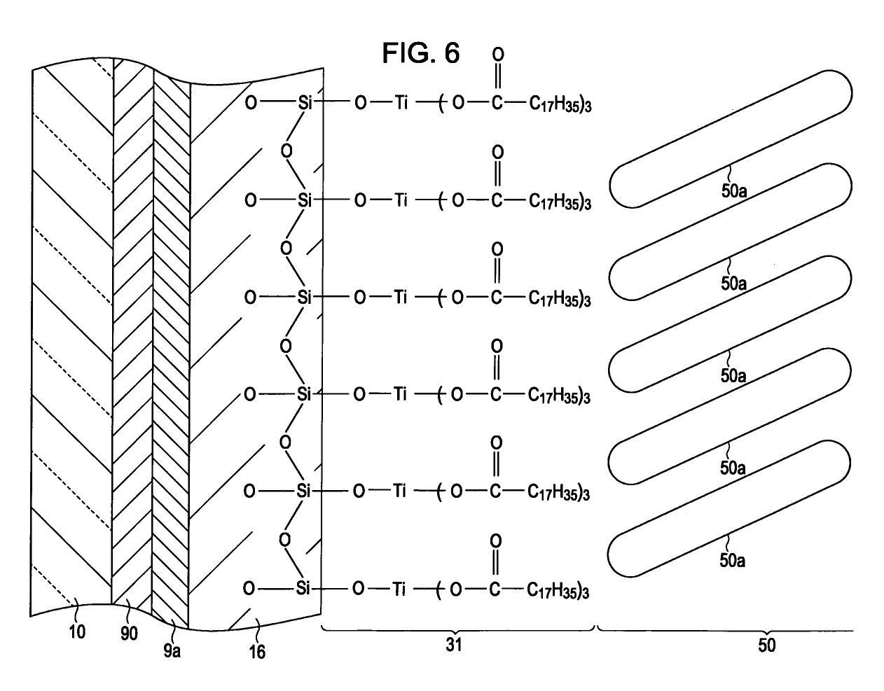

Turning now to FIG. 6, a second embodiment will be described. FIG. 6 is a schematic representation of the surface of a surface-treated alignment layer. The present embodiment is different from the first embodiment in that the surfaces of the alignment layers 16 and 22 are treated with a titanate coupling agent instead of the aluminate coupling agent. The description of the same points as in the first embodiment will be omitted.

### Chemical Structure at the Surface of Alignment Layer

In the liquid crystal device 1 according to the present embodiment, the entire surfaces of the alignment layers 16 and 22 are treated with a titanate coupling agent expressed by general formula (3). Specifically, the titanate coupling agent reacts with the hydroxy group (—OH group) of the silanol group being the active site present at the surface of each of the alignment layers 16 and 22, so that a reaction layer 31 is formed on the surfaces of the alignment layers 16 and 22. Thus, the silanol group photochemically reacting with the liquid crystal molecules can be reduced from the surfaces of the alignment layers 16 and 22.

Since the titanate coupling agent has a hydrophilic group at one end, the reaction layer 31 formed of the titanate coupling agent has a high affinity for the inherently hydrophilic inorganic alignment layers (alignment layers 16 and 22). Accordingly, water permeating from the outside or water contained in the liquid crystal is prevented from reaching the surfaces of the alignment layers 16 and 22 to form the silanol group again.

In addition, since the titanate coupling agent has a lipophilic group at the other end, the reaction layer 31 formed of the titanate coupling agent has a high affinity for the liquid crystal molecules containing an oil component. Accordingly, even if the silanol group is left at the surfaces of the alignment layers 16 and 22, the action of the silanol group to come close to the liquid crystal molecules can be relatively weakened to prevent the photochemical reaction of the liquid crystal molecules with reliability.

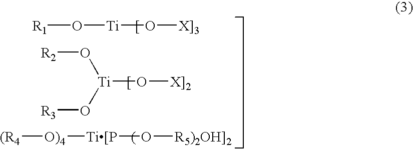

(R1 represents an alkyl group having a carbon number in the range of 1 to 6; X represents an organic group selected from among the groups containing C, N, P, S, O, and H; R2 and R3 represent organic groups having carbon numbers in the range of 1 to 20 and may contain an oxygen atom and they may be bound to each other; R4 represents an organic group having a carbon number in the range of 1 to 20 and may contain an oxygen atom; and R5 represents an alkyl group having a carbon number in the range of 1 to 20.)

Since the reaction layer 31 has a much smaller thickness than the alignment layers 16 and 22, the reaction layer 31 does not reduce the ability of the alignment layers 16 and 22 to align liquid crystal molecules.

Preferred examples of the titanate coupling agent expressed by general formula (3) include coupling agents having a carboxy group as an organic functional group, such as isopropyltriisostearoyl titanate, isopropyltrioctanoyl titanate, isopropyldimethacrylisostearoyl titanate, isopropylisostearoyldiacryl titanate, and diisostearoylethylene titanate, expressed by chemical formulas (4) to (8) respectively. The titanate coupling agent may be a coupling agent having a phosphite group as an organic functional group, such as tetraisopropylbis(dioctylphosphite)titanate or tetraoctylbis(ditridecylphosphite)titanate, expressed by chemical formula (9) or (10) respectively. The titanate coupling agent may be a coupling agent having a pyrophosphate group as an organic functional group, such as isopropyltris(dioctylpyrophosphate)titanate, bis(dioctylpyrophosphate)oxyacetate titanate, or bis(dioctylpyrophosphate)ethylene titanate, expressed by chemical formulas (11) to (13) respectively. The titanate coupling agent may be a coupling agent having an amino group as an organic functional group, such as isopropyltri(N-amidoethyl.aminoethyl)titanate expressed by chemical formula (14). Also, coupling agents having another organic functional group may be used, such as isopropyltricumylphenyl titanate and dicumylphenyloxyacetate titanate expressed by chemical formulas (15) and (16).

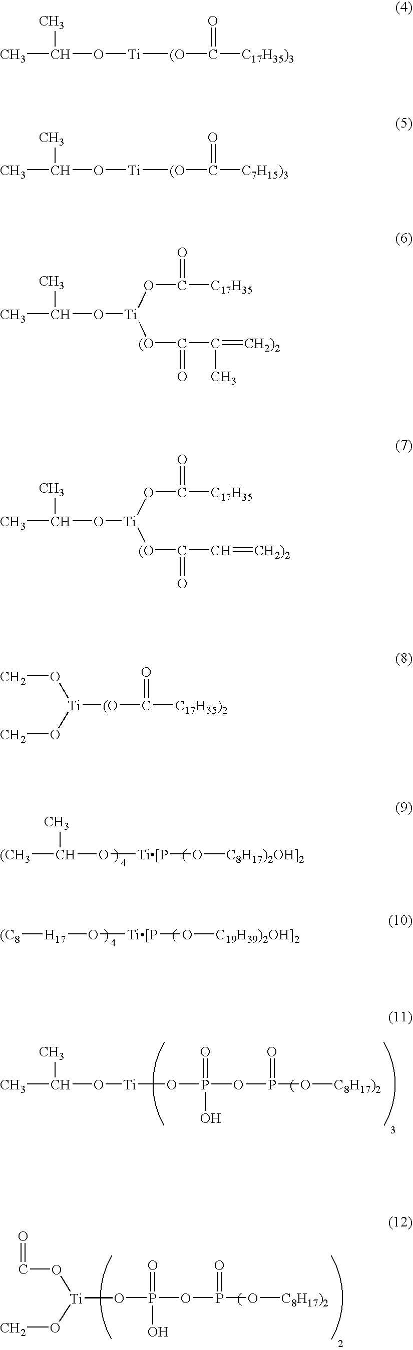

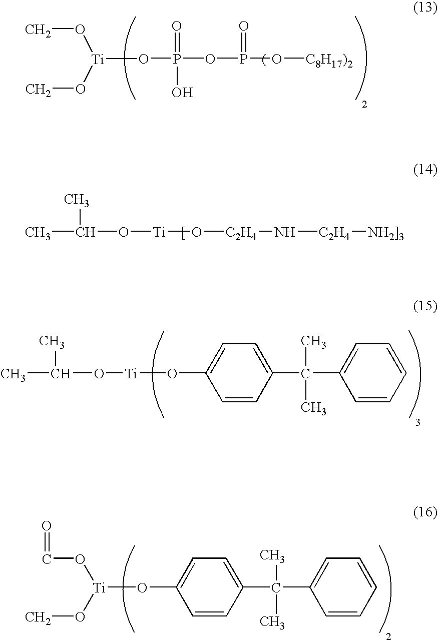

FIG. 6 schematically shows the sectional structure of the alignment layer 16 and its reaction layer 31 of isopropyltriisostearoyl titanate expressed by chemical formula (4) over the TFT array substrate 10, corresponding to the sectional view shown in FIG. 2.

In FIG. 6, the TFT array substrate 10 has the multilayer structure 90 including TFTs and other elements on the surface opposing the liquid crystal layer 50, and the pixel electrodes 9a formed for each pixel as the uppermost layer of the multilayer structure 90. The inorganic material is deposited in such a manner that columnar structures of the inorganic material are arranged on the pixel electrode 9a at a predetermined angle with respect to the surface of the TFT array substrate 10, thus forming the alignment layer 16. The thus formed alignment layer 16 can control the alignment of liquid crystal molecules 50a by its surface structure. Specifically, the liquid crystal molecules 50a are aligned in a direction tilted at a predetermined angle from the direction perpendicular to the surface of the substrate 10 (tilted homeotropic alignment), as shown in FIG. 6. The alignment layer 22 formed over the opposing substrate 20 also aligns the liquid crystal molecules 50a in the same manner.

The surface treatment of the alignment layers 16 and 22 is performed by immersing and heating the substrate having the inorganic homeotropic alignment layer in a solution of, for example, a titanate coupling agent with a predetermined concentration in an organic solvent. The surface treatment of the alignment layer is not limited to this method and may be performed by, for example, spin-coating the alignment layer with a coupling agent solution.

In the liquid crystal device according to the present embodiment, the inorganic homeotropic alignment layer is surface-treated with a titanate coupling agent to from the reaction layer on the surface of the inorganic homeotropic alignment layer. Thus, the activity at the surface is reduced, thereby inhibiting the reaction with the liquid crystal molecules. In addition, the reaction layer made of a titanate coupling agent has affinity for the liquid crystal molecules, and accordingly the liquid crystal molecules are drawn to the surface of the alignment layer. Accordingly, water contained in the liquid crystal layer can be prevented from reaching the surface of the alignment layer to form the silanol group again. Thus, the photochemical reaction between the liquid crystal molecules and the inorganic homeotropic alignment layer can be reduced, and consequently high-quality images can be displayed over a long term.

### Method for Manufacturing the Liquid Crystal Device

A method for manufacturing the liquid crystal device according to the present embodiment includes the same steps as shown in FIG. 5 referred to in the first embodiment, except that in Step S13 in the present embodiment, the surface opposing the liquid crystal layer 50 of the alignment layer 16 of the TFT array substrate 10 is treated with a coupling agent solution prepared by dissolving, for example, a titanate coupling agent in a solvent.

The inorganic homeotropic alignment layer of the opposing substrate 20, as well as that of the TFT array substrate 10, is surface-treated with a coupling agent solution containing a titanate coupling agent in Step S23.

Thus, the method for manufacturing the liquid crystal device according to the present embodiment can produce the above-described liquid crystal device. Since in this method, the surfaces of the alignment layers 16 and 22 opposing the liquid crystal layer 50 are treated with a titanate coupling agent, the resulting liquid crystal device can exhibit high light resistance.

### Third Embodiment

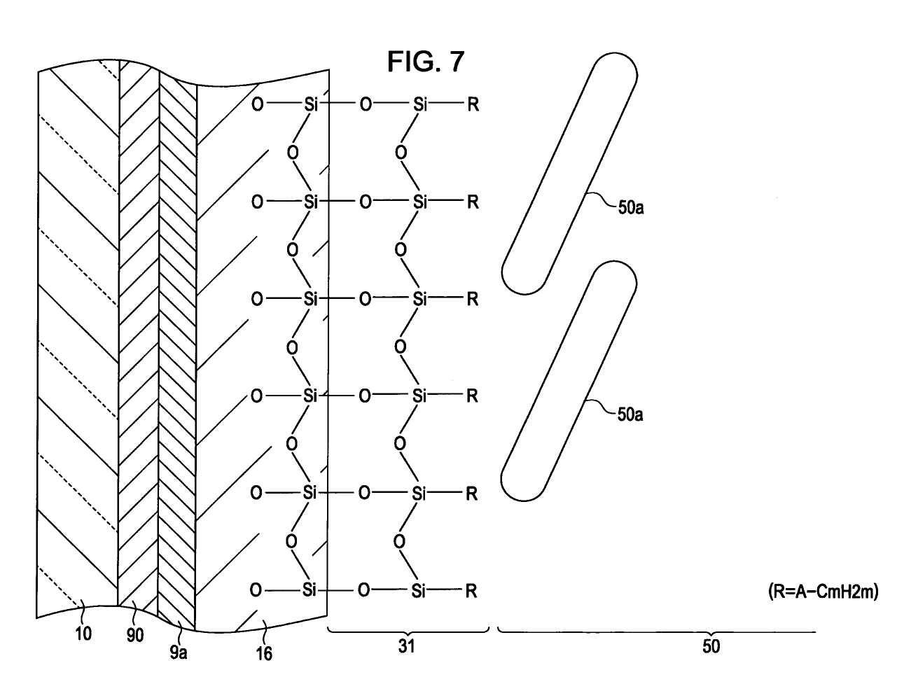

Turning now to FIG. 7, a third embodiment will be described. FIG. 7 is a schematic representation of the surface of a surface-treated alignment layer. The present embodiment is different from the first embodiment mainly in that the alignment layers 16 and 22 are inorganic homogeneous alignment layers and are surface-treated with an epoxy silane coupling agent. The description of the same points as in the first embodiment will be omitted.

The alignment layers 16 and 22 of the liquid crystal device 1 according to the present embodiment are made of an inorganic material in order to increase the lifetime. Furthermore, the alignment layers 16 and 22 are inorganic homogeneous alignment layer made of columnar crystals grown at a predetermined angle with respect to the substrate so as to align liquid crystal molecules in a homogeneous alignment mode. More specifically, the alignment layers 16 and 22 are inorganic tilted homogeneous alignment layers that align liquid crystal molecules in a direction tilted at a predetermined angle from the directions parallel to the surfaces of the substrates 10 and 20. The liquid crystal layer 50 is made of liquid crystals containing, for example, liquid crystal molecules having at least one positive dielectric constant anisotropy, and is in a predetermined aligned state between the pair of alignment layers 16 and 22 when no electric field is applied from the pixel electrode 9a.

### Chemical Structure at the Surface of Alignment Layer

The entire surfaces of the alignment layers 16 and 22 of the liquid crystal device 1 according to the present embodiment are treated with a silane coupling agent expressed by general formula (17).

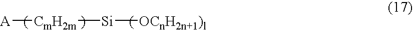

### (A represents a substituent, 1 represents an integer in the range of 1 to 3, m represents an integer in the range of 0 to 2, and n represents an integer in the range of 0 to 2.)

Preferably, substituents expressed by general formulas (18-1) to (18-3) can be used as the substituent A.

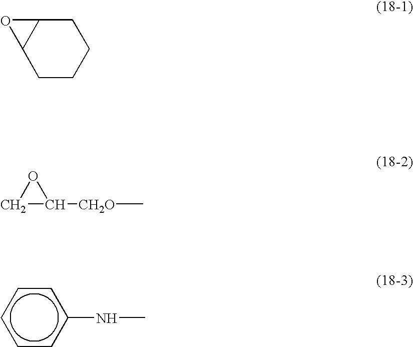

Specifically, the hydroxy group (—OH group) of the silanol group being the active site present at the surface of each of the alignment layers 16 and 22 reacts with a coupling agent to form a reaction layer 31, and the coupling agent may be an epoxy silane coupling agent having an epoxycyclohexyl group expressed by general formula (18-1), a glycidoxypropyl group expressed by general formula (18-2), or a phenylamino group expressed by general formula (18-3), each substituted for the substituent A of general formula (17). Thus, the silanol group photochemically reacting with the liquid crystal molecules can be reduced from the surface of the alignment layers 16 and 22.

The reaction layer 31 formed of an epoxy silane coupling agent and an amino silane coupling agent has a high affinity for liquid crystal molecules, accordingly increasing the ability of the alignment layer to align the liquid crystal molecules. FIG. 7 schematically shows the sectional structure when the reaction layer 31 is formed of a silane coupling agent on the surface of the alignment layer 16 over the TFT array substrate 10, corresponding to the sectional view shown in FIG. 2.

In FIG. 7, the TFT array substrate 10 has the multilayer structure 90 including TFTs and other elements on the surface opposing the liquid crystal layer 50, and the pixel electrode 9a formed for each pixel as the uppermost layer of the multilayer structure 90. The inorganic material is deposited in such a manner that columnar structures of the inorganic material are arranged on the pixel electrode 9a at a predetermined angle with respect to the surface of the TFT array substrate 10, thus forming the alignment layer 16. The thus formed alignment layer 16 can control the alignment of liquid crystal molecules 50a by its surface structure. Specifically, the liquid crystal molecules 50a are aligned in a direction tilted at a predetermined angle from the direction parallel to the surface of the substrate 10 (tilted homogeneous alignment), as shown in FIG. 7. The alignment layer 22 of the opposing substrate 20 also aligns the liquid crystal molecules 50a in the same manner.

Preferred examples of the epoxy silane coupling agent expressed by general formulas (17) and (18-1) include 2-(3,4-epoxycyclohexyl)ethyltrimethoxy silane expressed by chemical formula (19). Preferred examples of the epoxy silane coupling agent expressed by general formulas (17) and (18-2) include 3-glycidoxypropyltrimethoxy silane, 3-glycidoxypropylmethyldiethoxy silane, and 3-glycidoxypropyltrimethoxy silane expressed by chemical formulas (20) to (22) respectively. Preferred examples of the amino silane coupling agent expressed by general formulas (17) and (18-3) include 3-aminopropyltrimethoxy silane, 3-aminopropyltriethoxy silane, N-(2-aminoethyl)3-aminopropyltrimethoxy silane, and N-(2-aminoethyl)3-aminopropyltriethoxy silane expressed by chemical formulas (23) to (26) respectively.

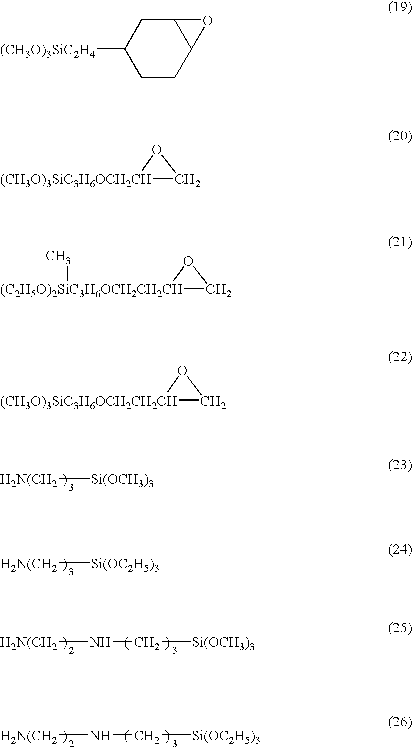

The surface treatment of the alignment layers 16 and 22 is performed by immersing and heating the substrate having the inorganic homogeneous alignment layer in a coupling agent solution of, for example, a silane coupling agent with a predetermined concentration in an organic solvent. The surface treatment of the alignment layer is not limited to this method and may be performed by, for example, spin-coating the alignment layer with a coupling agent solution.

In the liquid crystal device according to the present embodiment, the inorganic homogeneous alignment layer is surface-treated with an epoxy silane coupling agent or an amino silane coupling agent to replace the silanol group with the coupling agent. Thus, the silanol group can be reduced from the surface of the alignment layer, so that the photochemical reaction between the liquid crystal molecules and the alignment layer can be reduced. In addition, the reaction layer has a high affinity for liquid crystals. Accordingly, the ability to align the liquid crystal molecules can be enhanced and high-quality images can be displayed over a long term, as well as reducing the photochemical reaction between the liquid crystal molecules and the inorganic homogeneous alignment layer.

### Method for Manufacturing the Liquid Crystal Device

A method for manufacturing the liquid crystal device according to the present embodiment includes the same steps as shown in FIG. 5 referred to in the first embodiment, except that in the present embodiment, the inorganic homogeneous alignment layer is formed as the alignment layer 16 on the multilayer structure 90 of the TFT array substrate 10 in Step S12 and subsequently the surface opposing the liquid crystal layer 50 of the alignment layer 16 is treated with a coupling agent solution prepared by dissolving, for example, a silane coupling agent in a solvent in Step S13.

Also, in Step S22, an inorganic homogeneous alignment layer is formed as the alignment layer 22 on the top surface of the opposing electrode of the opposing substrate 20 as in the case of forming the TFT array substrate 10, and subsequently the alignment layer 22 is surface-treated with a coupling agent solution containing a silane coupling agent in Step S23.

Thus, the method for manufacturing the liquid crystal device according to the present embodiment can produce the above-described liquid crystal device. Since in this method, the surfaces of the alignment layers 16 and 22 opposing the liquid crystal layer 50 are treated with an epoxy silane coupling agent or an amino silane coupling agent, the resulting liquid crystal device can exhibit high light resistance and can enhance the ability to align liquid crystal molecules.

### Electronic Apparatus

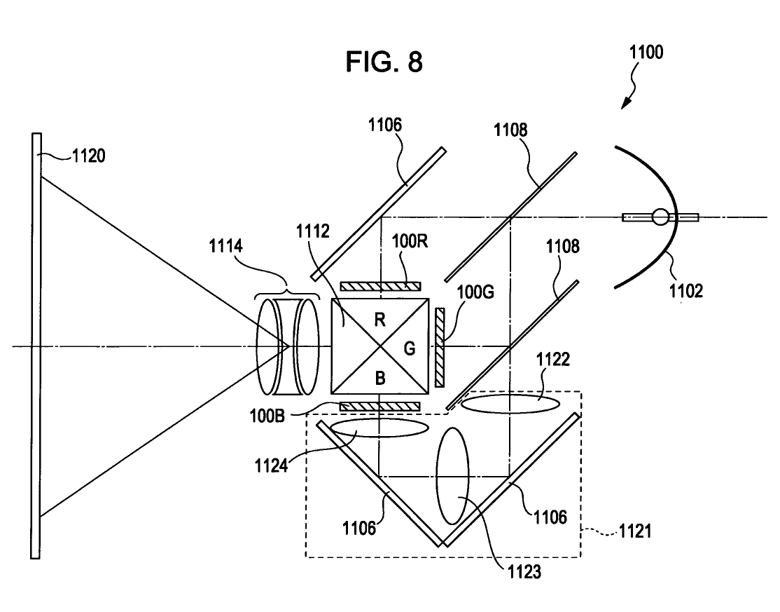

For describing an electronic apparatus using a liquid crystal device 1 according to the above-described embodiments as a light valve, a projection color display device will be described in its entire structure and optical structure. FIG. 8 is a representation of the projection color display device.

As shown in FIG. 8, a liquid crystal projector 1100 as an example of the projection color display device according to the present embodiment includes three liquid crystal modules used as R, G, and B light valves 100R, 100G, and 100B respectively, each including a liquid crystal device 1 whose driving circuit is disposed on the TFT array substrate 10. In the liquid crystal projector 1100, projection light is emitted from a lamp unit 1102 of a white light source, such as a metal halide lamp. The projection light is divided into three color components R, G, and B corresponding to the three primary colors by three mirror 1106 and two dichroic mirrors 1108. The color components are conducted to the respective light valves 100R, 100G, and 100B. In particular, B light is conducted through a relay lens system 1121 including an input lens 1122, a relay lens 1123, and an output lens 1124 to prevent the light loss due to the long optical path. The light components corresponding to the three primary colors, modulated by the light valves 100R, 100G, and 100B are synthesized again by a dichroic prism 1112 and then projected as a color image on a screen 1120 through a projection lens 1114. Since the projected color image is formed by a liquid crystal device whose alignment failure is reduced, the resulting color image can exhibit high quality.

In addition to the projection color display device (projector), other electronic apparatuses that can use any one of the liquid crystal devices according to the above-described embodiments include cellular phones, PDAs (personal digital assistants), portable personal computers, digital cameras, vehicle-mounted monitors, digital video cameras, liquid crystal TV sets, viewfinder-type and monitor-direct-view-type video tape recorders, car navigation systems, pagers, electronic notebooks, electronic calculators, word processors, work stations, videophones, and POS terminals.

The electro-optic devices according to the embodiments of the invention can be used not only in active matrix liquid crystal display device including TFTs, but also in various types of electro-optic devices, such as a liquid crystal display panel including TFDs (thin-film diodes) as switching elements and a passive matrix liquid crystal display device.

The invention is not limited to the above-described embodiments, and various changes and modifications in form and detail may be made without departing from the scope and sprit of the invention.

What is claimed is:

1. A method for manufacturing a liquid crystal device including a substrate and an inorganic homeotropic alignment layer made of an inorganic material and aligning liquid crystal molecules having a negative dielectric constant anisotropy in a direction tilted at a predetermined angle from the direction perpendicular to the surface of the substrate, the method comprising:
forming the inorganic homeotropic alignment layer; and
treating the surface of the inorganic homeotropic alignment layer with an aluminate coupling agent.

2. The method according to claim 1, wherein the inorganic homeotropic alignment layer is formed on the opposing surfaces of a first substrate and a second substrate that are bonded together with a sealant so as to hold a liquid crystal layer therebetween, and the treatment with the aluminate coupling agent is performed on at least the region of the surface of the inorganic homeotropic alignment layer coming in contact with the sealant.

3. The method according to claim 1, wherein the aluminate coupling agent is acetoalkoxyaluminum diisopropylate.

4. A method for manufacturing a liquid crystal device including a substrate and an inorganic homeotropic alignment layer made of an inorganic material and aligning liquid crystal molecules having a negative dielectric constant anisotropy in a direction tilted at a predetermined angle from the direction perpendicular to the surface of the substrate, the method comprising:
forming the inorganic homeotropic alignment layer; and
treating the surface of the inorganic homeotropic alignment layer with a titanate coupling agent.

5. The method according to claim 4, wherein the titanate coupling agent is a substance selected from the group consisting of isopropyltriisostearoyl titanate, isopropyltrioctanoyl titanate, isopropyldimethacrylisostearoyl titanate, isopropylisostearoyldiacryl titanate, diisostearoylethylene titanate, tetraisopropylbis(dioctylphosphite)titanate, tetraoctylbis(ditridecylphosphite)titanate, isopropyltris(dioctylpyrophosphate)titanate, bis(dioctylpyrophosphate)oxyacetate titanate, bis(dioctylpyrophosphate)ethylene titanate, isopropyltri(N-amidoethyl aminoethyl)titanate, isopropyltricumylphenyl titanate, and dicumylphenyloxyacetate titanate.

6. A method for manufacturing a liquid crystal device including a substrate and an inorganic homogeneous alignment layer made of an inorganic material and aligning liquid crystal molecules having a positive dielectric constant anisotropy in a direction tilted at a predetermined angle from the direction parallel to the surface of the substrate, the method comprising:
forming the inorganic homogeneous alignment layer; and
treating the surface of the inorganic homogeneous alignment layer with an epoxy silane coupling agent.

7. A method for manufacturing a liquid crystal device including a substrate and an inorganic homogeneous alignment layer aligning liquid crystal molecules having a positive dielectric constant anisotropy in a direction tilted at a predetermined angle from the direction parallel to the surface of the substrate, the method comprising:
forming the inorganic homogeneous alignment layer; and
treating the surface of the inorganic homogeneous alignment layer with an amino silane coupling agent.
